(19) United States
(12) Patent Application Publication
(10) Pub. No.: US 2002/0052774 A1
(43) Pub. Date: May 2, 2002

(54) Collecting and analyzing survey data

(76) Inventors: Lance Parker, New York, NY (US); Fernando Alvarez, Melville, NY (US); Michael H. Coen, Somerville, MA (US)

Correspondence Address: P. LOUIS MEYERS, Fish & Richardson P.C., 225 Franklin Street, Boston, MA, 02110-2804, US

(21) Appl. No.: 09/747,160

(22) Filed: Dec. 22, 2000

Related U.S. Application Data
(60) Provisional application No. 60/173,014, filed on Dec. 23, 1999.

(51) Int. Cl. G06F 17/60

(52) U.S. Cl. 705/10

(57) ABSTRACT

A computer-implemented process includes distributing a first, general survey, receiving responses to the first survey, analyzing the responses automatically, and obtaining a second survey based on the analysis of the responses. The second survey is more specific than the first survey. The process further includes distributing the second survey, receiving responses to the second survey, analyzing the responses to the second survey automatically, obtaining a third, still more specific, survey based on the analysis of the responses to the second survey, and repeating the process using the third survey.

### CROSS-REFERENCE TO RELATED APPLICATIONS

This application claims priority from U.S. Provisional Application No. 60/173,014, filed on Dec. 23, 1999. The contents of U.S. Provisional Application No. 60/173,014 are hereby incorporated by reference into this application as if set forth herein in full.

### BACKGROUND

This invention relates generally to collecting data using surveys and, more particularly, to analyzing the survey data, visually displaying survey results, and running new surveys based on the analysis.

Businesses use survey information to determine their strengths and weaknesses in the marketplace. Current methods of running surveys involve formulating questions, distributing the survey to potential respondents, and analyzing the responses mathematically to obtain the desired information. Much of this process is performed manually, making it time-consuming and, usually, costly.

### SUMMARY

In general, in one aspect, the invention is a computer-implemented method that includes distributing a first survey, receiving responses to the first survey, analyzing the responses automatically, and obtaining a second survey based on the analysis of the responses. By performing the method automatically, using a computer, it is possible to conduct surveys more quickly and efficiently that has heretofore been possible using manual methods.

This aspect of the invention may also include distributing the second survey, receiving responses to the second survey, analyzing the responses to the second survey automatically, and obtaining a third survey based on the analysis of the responses to the second survey. The first survey is a general survey and the second survey is a specific survey that is selected based on the responses to the general survey. The second survey is obtained by selecting sets of questions from a database based on the responses to the first survey and combining the selected sets of questions to create the second survey.

The analysis of the responses may include validating the responses and is performed by computer software, without human intervention. The results of the first survey are determined based on the responses and displayed, e.g., on a graphical user interface. The analysis may include identifying information in the responses that correlates to predetermined criteria and displaying that information on the graphical user interface.

The first survey is distributed over a computer network to a plurality of respondents and the responses are received at a server, which performs the analysis, over a computer network. The first survey contains questions, each of which is formatted as a computer-readable tag. The responses include replies to each of the questions, which are formatted as part of the computer-readable tags. The analysis is performed using the computer-readable tags.

A library of survey templates is stored and the first and second surveys are obtained using the library of templates. The first and second surveys are obtained by selecting survey templates and adding information to the selected survey templates based on a proprietor of the first and second surveys. The method may include recommending the second survey based on the responses to the first survey and retrieving the second survey in response to selection of the second survey.

In general, in another aspect, the invention features a graphical user interface (GUI), which includes a first area for selecting an action to perform with respect to a survey and a second area for displaying information that relates to the survey.

This aspect of the invention may include one or more of the following features. The second area displays status information relating to a recently-run survey and the GUI also includes a third area for displaying an analysis of survey results. The status information includes a date and a completion status of the recently-run survey. The analysis of survey results includes information indicating a change in the results relative to prior survey results. The GUI displays plural actions to perform. One of the actions includes displaying a report that relates to the survey. The report includes pages displaying information obtained from the survey and information about a product that is the subject of the survey. The information includes a comparison to competing products.

Other features and advantages of the invention will become apparent from the following description, including the claims and drawings.

### DESCRIPTION OF THE DRAWINGS

FIG. 1 is a block diagram of a network.

FIG. 2 is a flowchart showing a process for conducting surveys over the network.

FIGS. 3 to 17 are screen-shots of graphical user interfaces that are generated by the process of FIG. 2.

Like reference numerals in different drawings indicate like elements.

### DESCRIPTION

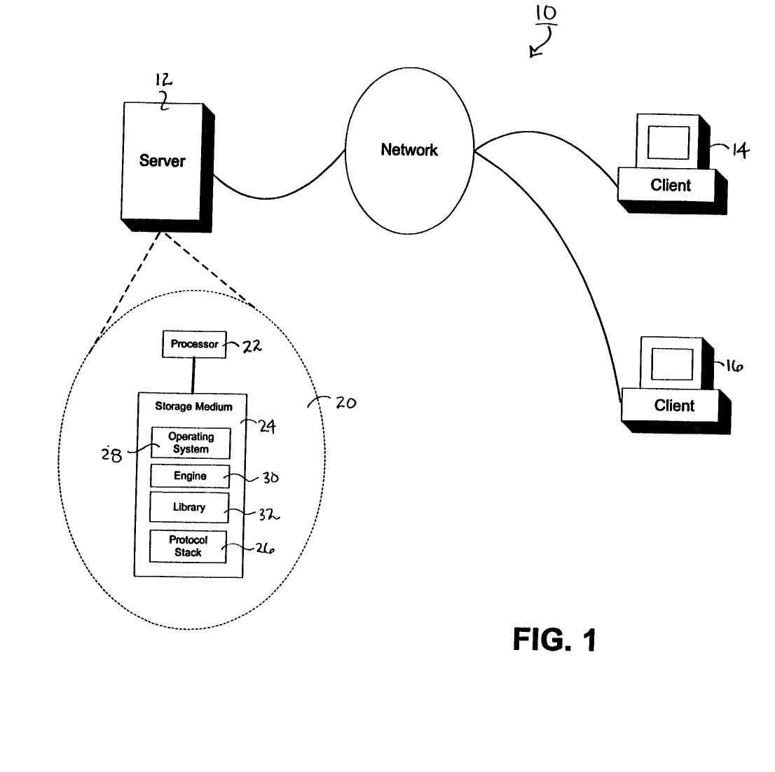

FIG. 1 shows a network 10. Network 10 includes a server 12, which is in communication with clients 14 and 16 over network 10. Network 10 may be any type of private or public network, such as a wireless network, a local area network (LAN), a wide area network (WAN), or the Internet.

Clients 14 and 16 are used by respondents to complete surveys distributed by survey proprietors. Clients 14 and 16 may be any type of device that is capable of transmitting and receiving data over a network. Examples of such devices include, but are not limited to, personal computers (PCs), laptop computers, hand-held computers, mainframe computers, automatic teller machines (ATMs) and specially-designed kiosks for collecting data. Each of clients 14 and 16 includes one or more input devices, such as a touch-sensitive screen, a keyboard and/or a mouse, for inputting information, and a display screen for viewing surveys. Any number of clients may be on network 10.

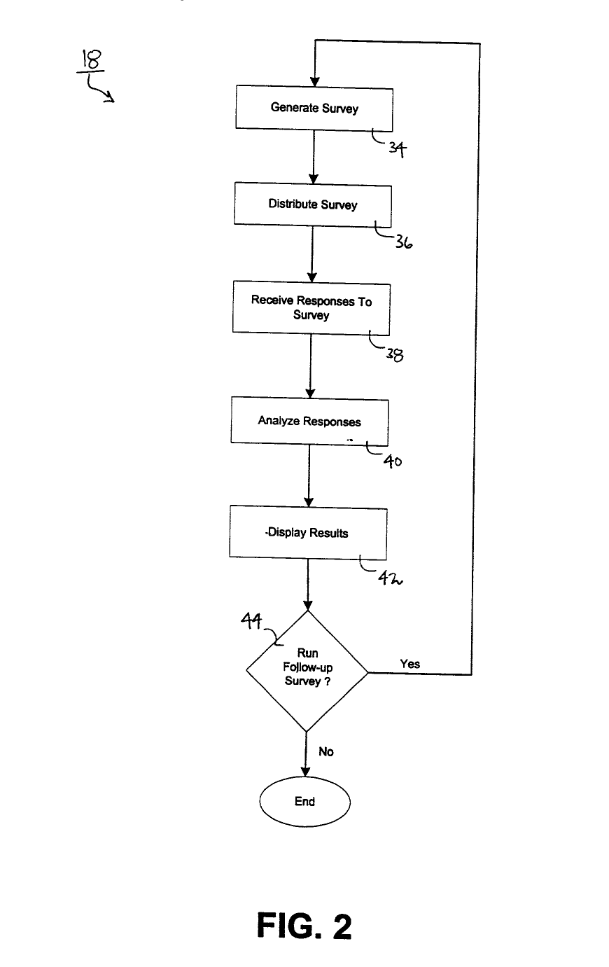

Server 12 is a computer, such as a PC or mainframe, which executes one or more computer programs (or “engines”) to perform process 18 (FIG. 2) below. That is, server 12 executes a computer program to generate surveys, validate and analyze survey responses, recommend and generate follow-up surveys, and display survey results.

View 20 shows the architecture of server 12. The components of server 12 include a processor 22, such as a microprocessor or microcontroller, and a memory 24. Memory 24 is a computer hard disk or other memory storage device, which stores data and computer programs. Among the computer programs stored in memory 24 are an Internet Protocol (IP) stack 26 for communicating over network 10, an operating system 28, and engine 30. Engine 30 includes computer-executable instructions that are executed by processor 22 to perform the functions, and to generate the GUIs, described herein.

The data stored in memory 24 includes a library 32 of survey templates. The library of survey templates may be complete surveys with “blanks” that are filled-in with information based on the identity of the survey's proprietor. Alternatively, library 32 may contain sets of questions organized by category with appropriate “blanks” to be filled in. The survey templates are described below.

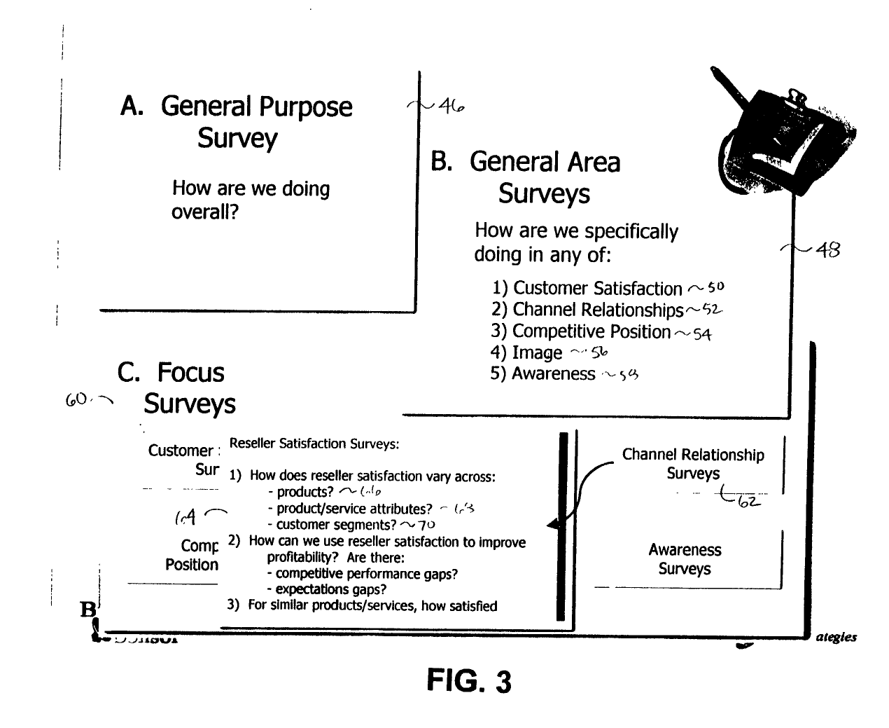

Referring now to FIG. 2, process 18 is shown for generating, distributing, and analyzing surveys. Process 18 is performed by engine 30 running on processor 22 of server 12. The specifics of process 18 are described below with respect to the GUIs of FIGS. 3 to 17.

In FIG. 2, process 18 generates (34) a survey and distributes (36) the survey to clients 14 and 16. Respondents at clients 14 and 16 complete the survey and provide their responses to server 12 over network 10. Server 12 receives (38) the responses and analyzes (40) the responses. When analyzing the responses, process 18 validates them by, e.g., determining if there are appropriate correlations between responses. For example, if one response to a survey indicates that a respondent lives in a poor neighborhood and another response indicates that the respondent drives a very expensive car, the two responses may not correlate, in which case process 18 rejects the response altogether.

Process 18 displays (42) the results of the analysis to a proprietor of the survey and determines (44) if a follow-up survey is to be run. If a follow-up survey is run, process 18 is repeated for the follow-up survey.

In this regard, engine 30 provides different levels of surveys, from general surveys meant to obtain high-level information, such as overall customer satisfaction, to focused surveys meant to obtain detailed information about a specific matter, such as reseller satisfaction with specific aspects of after-sale service or support. Thus, as described below, process 18 may run a high-level survey initially and then follow-up with one or more specific surveys to obtain more specific information about problems or questions identified through the high-level survey.

In this embodiment, there are three survey levels: general purpose surveys, general area surveys, and focus surveys. Referring to FIG. 3, a general purpose survey 46 includes questions which are intended to elicit general information about how the survey proprietor is faring in the marketplace. Generic questions relating to product awareness, customer satisfaction, and the like are typically included in the general purpose survey.

The general area surveys 48 are meant to elicit information pertaining to a particular problem or question that may be identified via the general purpose survey. In this embodiment, there are five general area surveys 48, which elicit specific information relating to critical marketing metrics, including customer satisfaction 50, channel relationships 52 (meaning the satisfaction of entities in channels of commerce, such as distributors and wholesalers), competitive position 54, image 56, and awareness 58. One or more general area surveys may be run following the general purpose survey or they may be run initially, without first running a general purpose survey.

The focus surveys 60 include questions that are meant to elicit more specific information that relates to one of the general area surveys. For example, as shown in FIG. 3, for channel relationships 62 alone, there are a number of focus surveys 64 that elicit information about, e.g., how reseller satisfaction varies across products 66, across product service attributes 68, across customer segments 70, etc. In the example shown in FIG. 3, there are seven focus surveys that elicit more specific information about channel relationships. One or more focus surveys may be run following a general area survey or they may be run initially, without first running a general area survey.

Templates for the surveys, including the general purpose survey, the general area surveys, and the focus surveys, are stored in library 32. These templates include questions with blank sections that are filled-in based on the business of the proprietor. This information to be included in the blank sections may be obtained using an expert system running on server 12 or it may be “hard-coded” within the system. The expert system may be part of engine 30 or it may be a separate computer program running on server 12. More information, and examples of, templates used in the system is found in Appendix III below.

The templates may be complete surveys or sets of questions that are to be combined to create a complete survey. For example, different sets of questions may be included to elicit attitudes of the respondent (e.g., attitude towards a particular company or product), behavior of the respondent, and demographic information for the respondent. The expert system mentioned above may be used to select appropriate sets of questions, e.g., in response to input from the survey proprietor, to fill-in the “blanks” of those questions appropriately, and to combine the sets of questions to create a complete survey. The structure of a complete survey template begins with a section of behavioral questions (e.g., “When did you last purchase product X?”), followed by a section of attitudinal questions (e.g., “What do you think of product X?”), and ends with a section of demographic questions for classification purposes (e.g., “What is your gender?”).

Several different templates for each type of survey may be included in library 32. For example, there may be several different templates for the general purpose survey. Which template is used for a particular company or product is determined based on whether the questions in that survey are appropriate for the company or product. For example, library 32 may contain a general purpose survey template that relates to manufactured goods and one that relates to service offerings. The questions on each would be inappropriate for the other. Therefore, the expert system selects an appropriate template and then fills in any blank sections accordingly based on information about the proprietor.

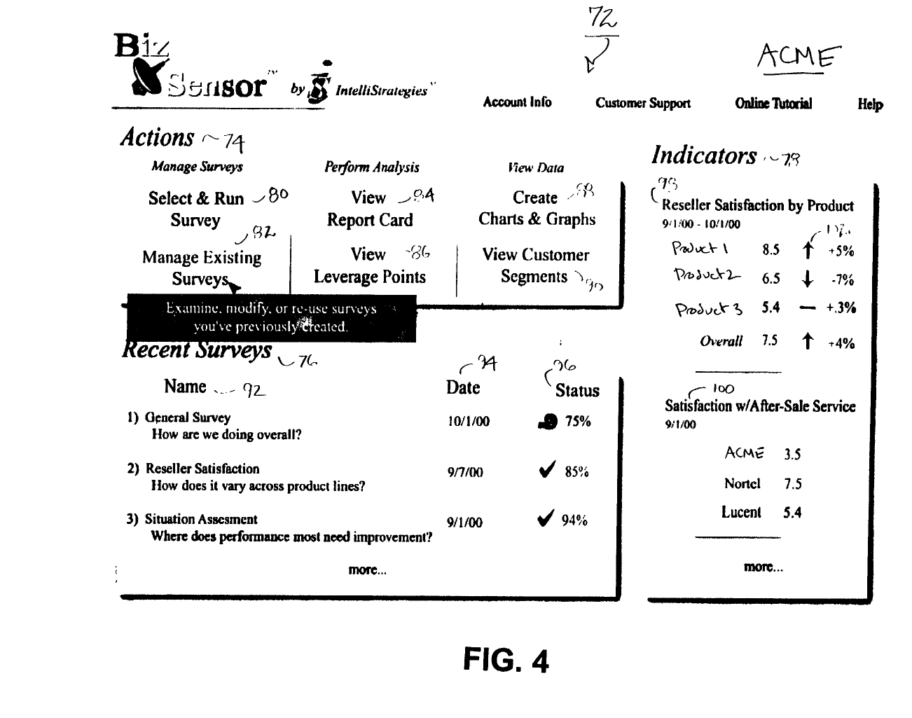

Referring now to FIG. 4, engine 30 generates and displays GUI 72 to a survey proprietor. GUI 72 is the initial screen that is generated by engine 30 when running a survey in accordance with process 18.

GUI 72 includes actions area 74, recent surveys area 76, and indicators area 78. Actions area 74 provides various options that relate to running a survey. As is the case with all of the options described herein, each of the options shown in FIG. 4 may be selected by pointing and clicking on that option. Briefly, option 80 generates and runs a survey. Option 82 examines, modifies or runs previously generated surveys. Option 84 displays information relating to a survey. Option 86 displays system leverage points. Option 88 displays survey responses graphically using, e.g., charts and graphs. Option 90 views customer (respondent) information from a survey according to demographics. That is, option 90 breaks-down survey responses according to the demographic information of a customer/respondent.

Recent surveys area 76 displays information relating to recently-run surveys, such as the name of survey 92, the date 94 that the survey was run, and the status 96 of the survey, e.g., the response rate.

Indicators area 78 includes information obtained from responses to earlier surveys. In the example shown, this information includes reseller satisfaction by product 98 and satisfaction with after-sale service 100. Arrows 102 are provided to indicate movement since this information was collected by one or more previous surveys. If no prior survey was run, arrows are not provided, as is the case in after-sale service 100.

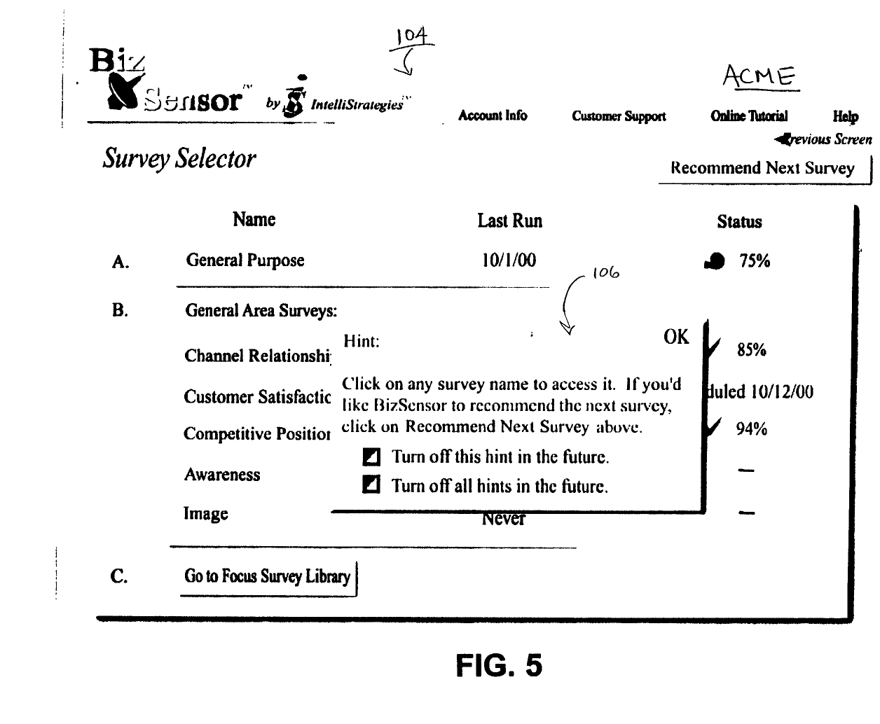

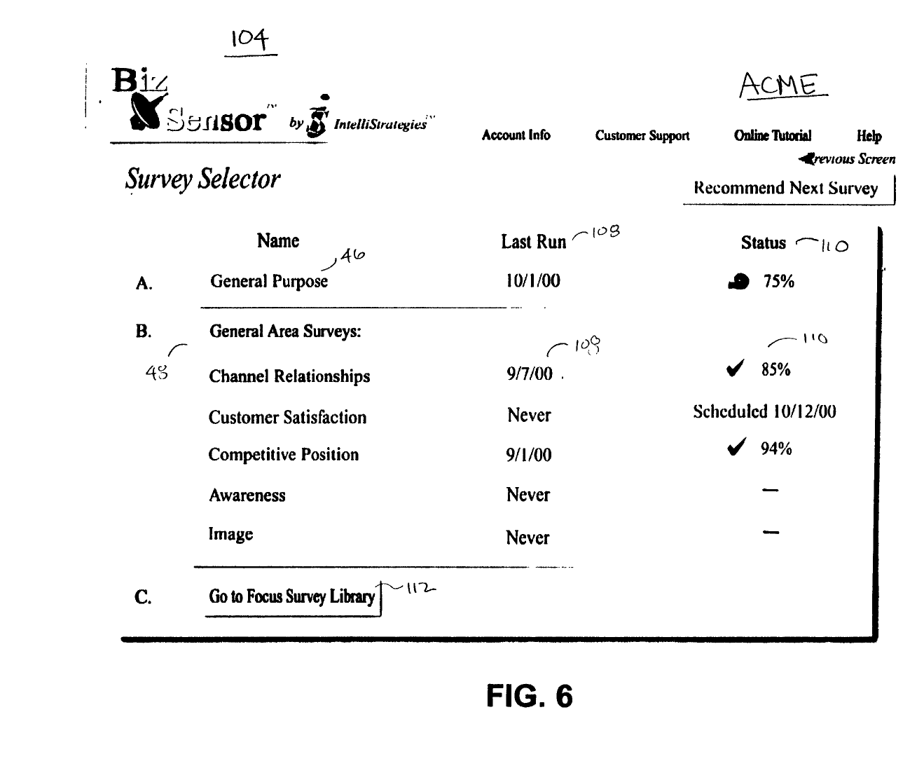

Selecting option 80 displays GUI 104, the “Survey Selector” (FIG. 5). A “hint” 106 may be provided when GUI 104 is first displayed to provide information about GUI 104. Referring to FIG. 6, GUI 104 lists the general purpose survey 46, the general area surveys 48, when they were last run 108, and their completion status 110.

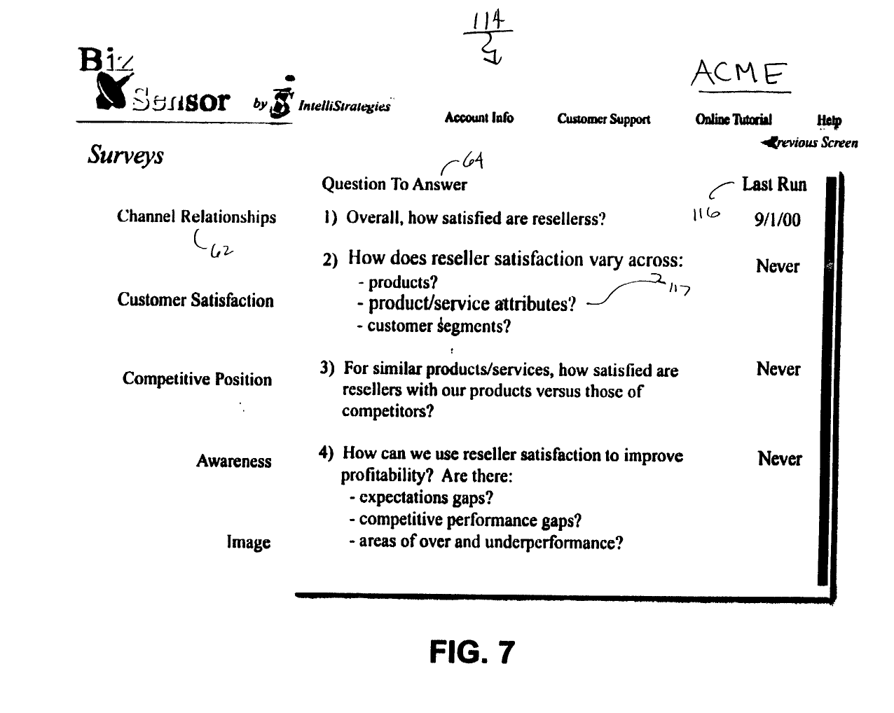

GUI 104 also contains an option 112 to obtain focus surveys from a focus survey library, e.g., library 32. Selecting option 112 displays GUI 114 (FIG. 7), which lists the focus surveys 64 for a selected general area survey 62. GUI 114 displays a list of the focus surveys 64, together with the date 116 on which each focus survey was last run. “Never” indicates that a survey has never been run.

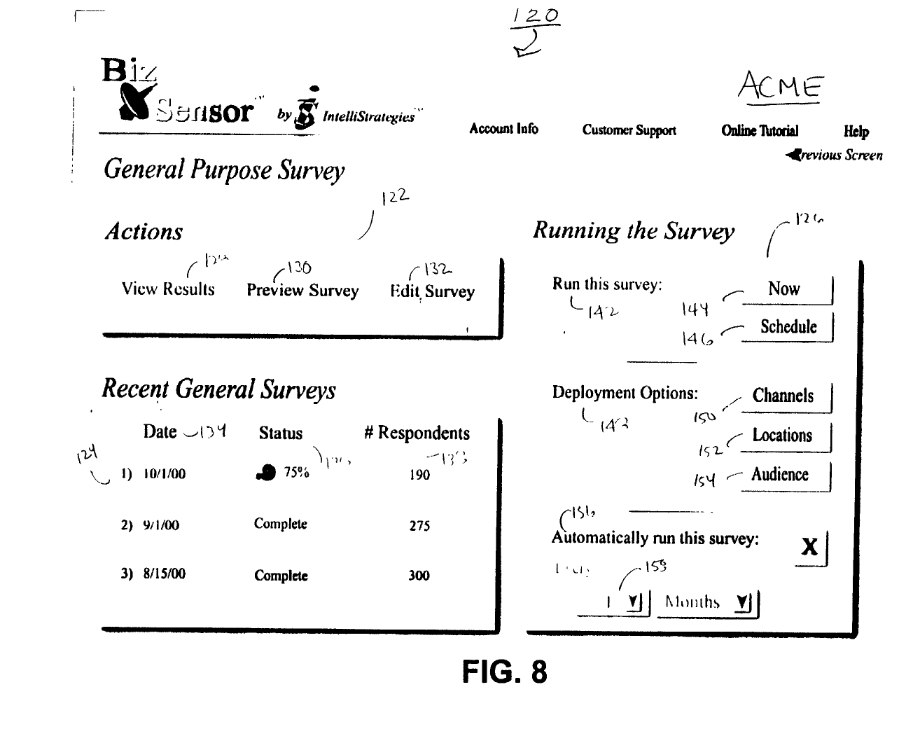

Referring back to FIG. 6, selecting general purpose option 46 displays GUI 120 (FIG. 8). GUI 120 summarizes information relating to the general purpose survey. Similar GUIs are provided for each general area survey and focus survey. Only the GUI 120 corresponding to the general purpose survey is described here, since substantially identical features are included on all such GUIs for all such surveys.

Engine 30 generates and distributes a survey based on the input(s) to GUI 120. GUI 120 includes areas 122, 124 and 126. Area 122 includes actions that may be performed with respect to a survey. These actions include viewing the results 128 of the survey, previewing the survey 130 before it is run, and editing the survey 132.

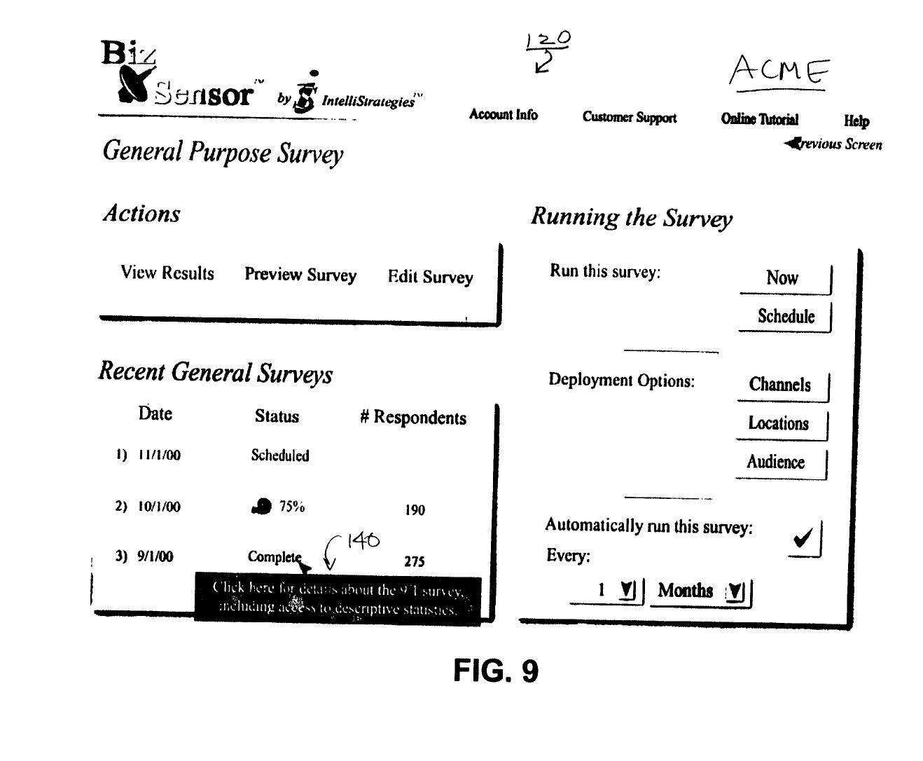

Area 124 contains information about the recently-run general surveys, including, for each survey, the date 134 the survey was run, the completion status 136 of the survey, and the number of respondents 138 who replied to the survey. Clicking on completion status 136 provides details about the corresponding survey, as shown by hint 140 displayed in FIG. 9.

Area 126 contains options 142 for running the general purpose survey. These options include whether to run the survey immediately (“now”) 144 or to schedule 146 the survey to run at a later time. In this context, running the survey includes distributing the survey to potential respondents at, e.g., clients 14 and 16, receiving responses to the survey, and analyzing the responses.

As described above, the survey is distributed to clients 14 and 16 via a network connection, allowing for real-time distribution and response-data collection. Each survey question and response is formatted as a computer-readable tag that contains a question field and an associated response field. Engine 30 builds questions for the survey by inserting data into the question field. The response field contains placeholders that contain answers to the corresponding questions. When a respondent replies to a survey question, the tag containing both the question and the response is stored in server 12. At server 12, engine 30 parses the question field to determine the content of the question and parses the response field to determine the response to the question. A detailed description of the tags used in one embodiment of the invention is described below in Appendix I.

Area 126 also includes options 148 for deploying, i.e., distributing, the survey to respondents. Information to distribute the surveys may be stored in memory 24. This information may include, for example, respondents' electronic mail (e-mail) addresses or network addresses of clients 14 and 16. Channels option 150 specifies to whom in a distribution channel, e.g., salesperson, retailer, etc., the survey is to be distributed. Locations option 152 specifies the locations at which survey data is to be collected. For example, for B2B (business-to-business) clients, option 152 may list sales regions. For B2C (business-to-customer) clients, option 152 may specify locations, such as a store or mall. Audience option 154 specifies demographic or other identifying information for the respondents. For example, audience option 154 may specify that the survey is to be distributed only to males between the ages of eighteen and twenty-four.

Area 126 also includes an option 156 for automatically running the current general purpose survey. If selected, as is the case in this example, server 12 automatically runs the survey at the interval specified at 158. (When options are selected, they are highlighted, as shown.)

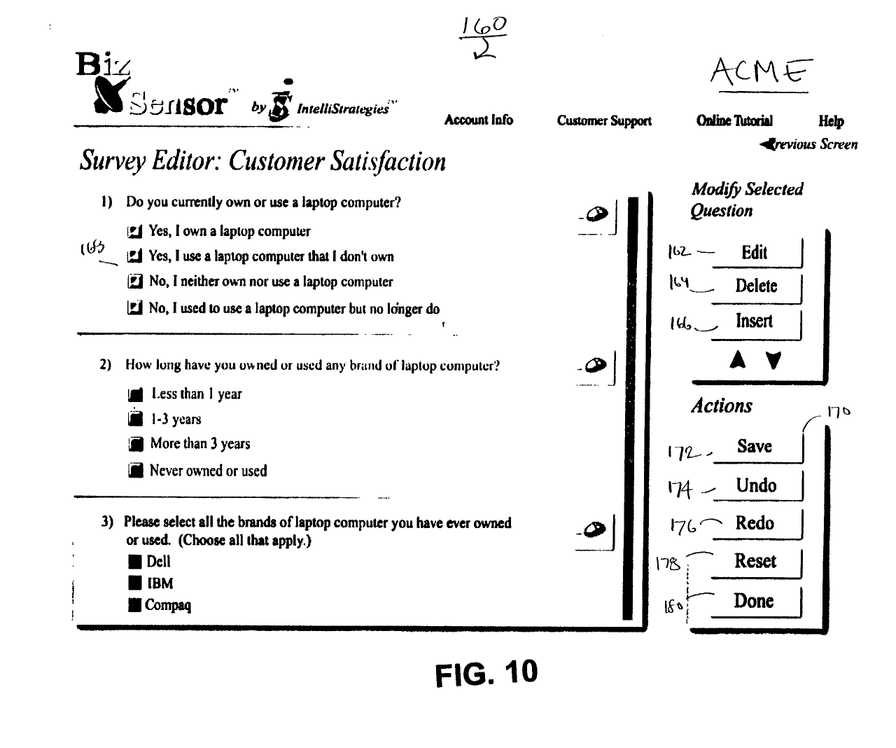

Selecting edit survey option 132 displays GUI 160 (FIG. 10). GUI 160 allows the proprietor of the current, general purpose survey to edit 162, delete 164, and/or insert 166 questions into the current survey. The questions are displayed in area 168, from which the proprietor can make appropriate modifications. Actions that may be performed on the modified survey are shown in area 170 and include save 172, undo 174, redo 176, reset 178, and done 180.

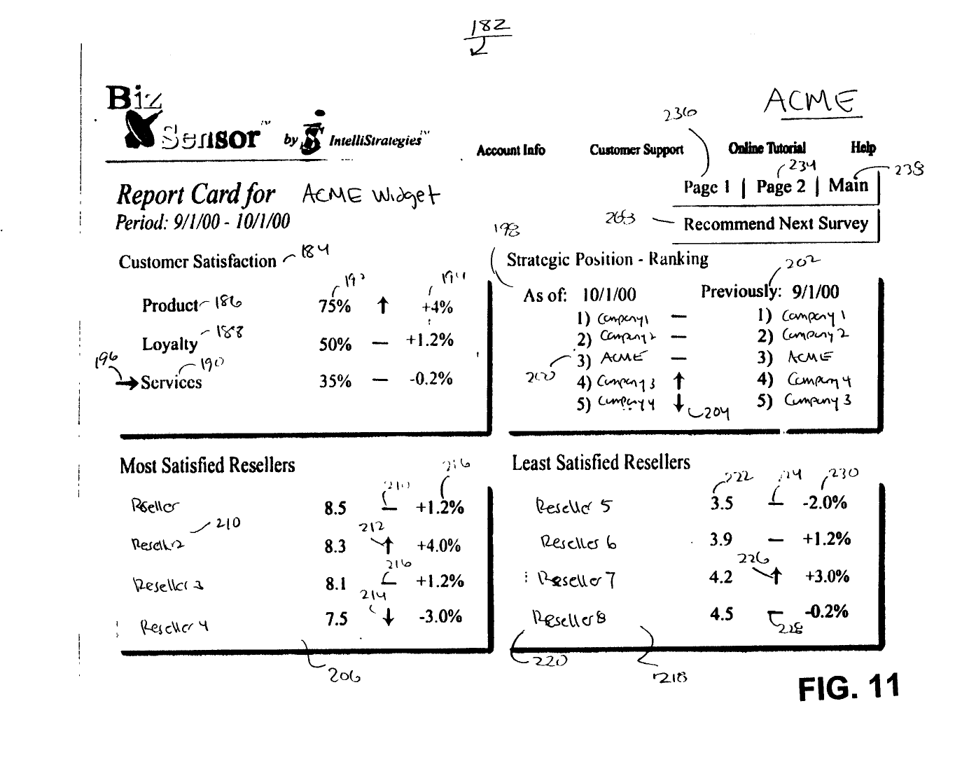

Referring back to FIG. 8, selecting view results option 128 displays GUI 182 (FIG. 11). In this regard, engine 30 generates two primary types of data displays: the “Report Card” and customized survey displays.

The Report Card is a non-survey-specific display that brings important indicator trends, movement, and values to the user's attention. Any data from any survey that has run may appear on the report card. Engine 30 can automatically derive this data from user responses.

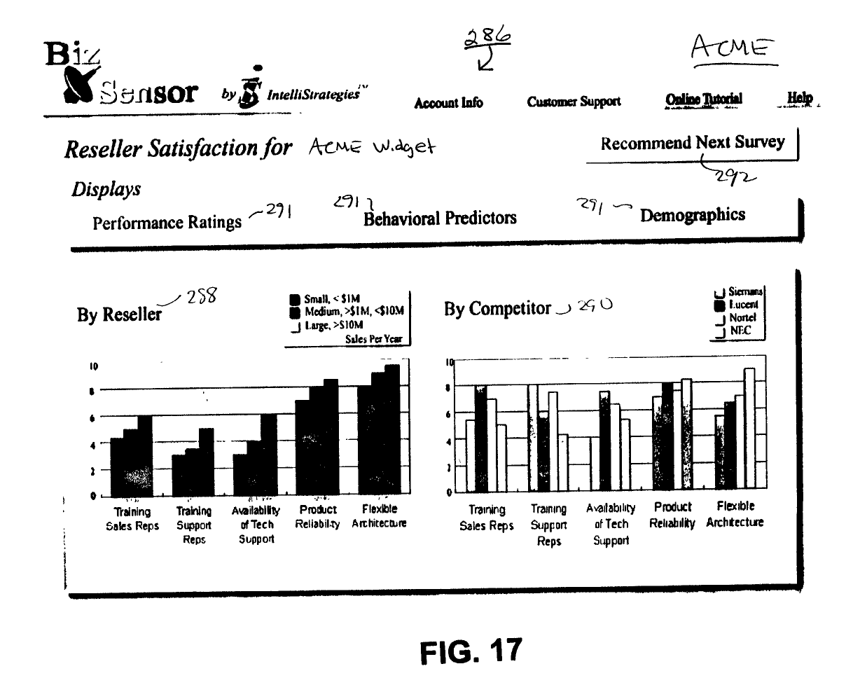

Customized Survey Displays are generated from tags stored with each survey that specify how that survey's results are best presented to users. This is considered expert-level knowledge and typically requires expertise in quantitative data visualization, statistical mathematics, marketing concepts, and data manipulation techniques in analytic software packages. For each survey, engine 30 encodes a set of stereotypical ways the data from that survey is generally viewed by marketers, so that users need not directly manipulate data gathered by a survey to see results. Customized data displays for a particular survey may be obtained via options 291 on FIG. 17.

Referring back to FIG. 11, GUI 182 is the first “page” of a two-page Report Card that relates to the subject of the survey. Engine 30 identifies information in the responses that correlates to predetermined criteria, such as customer satisfaction, and displays the relevant information on the report card.

Some of the information displayed on the report card, such as information relating to product quality and reliability, does not reflect answers to specific survey questions, but rather is derived from various questions. Such information is referred to as “derived attributes”. That is, a derived attribute is a metric that is not asked about directly on a survey, but instead is calculated from a subset of respondents' answers, which are proxies for that attribute. Derived attributes are either aggregate measures that cannot be directly determined or are quantities that are considered too sensitive to directly inquire about or unlikely to provide reliable responses.

Engine 30 includes a set of default rules for creating known derived attributes from facts asserted when respondents fill out surveys. For example, directly asking respondents about their income levels provides very poor quality information as their actual average income increases. However, any combination of demographic information such as zip code, favorite periodicals, type of car, and highest education level can be proxies for deriving respondent income. Thus, any surveys that contain these proxies can be used to derive income information given particular confidence intervals.

Derived attributes can also be used to summarize survey data. For example, in the domain of manufactured goods, quality, reliability, and product design are proxies for the more general derived attribute workmanship, which is difficult to ask about directly. Rather than display these three attributes separately, it can be more succinct and informative to display a single derived attribute for which they are proxies, assuming the existence of a high correlation among them. Particularly in a system such as this, which tries to bring the smallest amount of important information to the user's attention, derived attributes provide a means for reducing the amount of data that a user is forced to confront directly.

Engine 30 automatically tries to determine derived attributes when their proxy attributes are known. As survey data is gathered by the expert system, engine 30 tries to determine whether it can instantiate any derived attributes as facts in the expert system. A derived attribute, in turn, can be instantiated when a sufficiently large subset of its proxy attributes have been gathered via survey responses that there is sufficient confidence its value can be determined directly. The confidence intervals are determined using student T-distributions because the distribution underlying the proxy values is unknown. Engine 30 also does a time-series correlation analysis to determine which proxy attributes mostly strongly influence a derived attribute and subsequently adjusts weights in its generating function to reflect those proxy attributes. Thus, the precise generating function for a derived attribute need not be known in advance but can be determined from a series of “calibration” questions. Derived attributes are also used by engine 30 to recommend follow-up surveys, as described below.

In the example of FIG. 11, the subject of the survey is the fictitious ACME widget to indicate that the subject may be anything. The report card includes information obtained/derived from all surveys run by the current proprietor, not just from the latest survey. When results from one or more surveys are received and analyzed, the results of the analyses are combined, interpreted, and displayed on GUI 182.

In this embodiment, GUI 182 displays indications of customer satisfaction 184 with a product 186, customer services 190, and customer loyalty 188. Included in this display are percentages 192 of respondents who replied favorably in these categories and any changes 194 since a previous survey was run. An arrow 196 indicates a potential area of concern. For example, the 35% customer service satisfaction level is flagged as problematic.

Engine 30 determines whether a category is problematic based on the survey information and information about the proprietor's industry. For example, a sales slump in January typically is not an indication of a problem for retailers because January is generally not a busy month. On the other hand, a drop in sales during the Christmas season may be a significant problem. The same type of logic holds true for the product, loyalty and services categories.

Area 198 displays the position 200 in the marketplace of the survey proprietor relative to its competitors. This information may be obtained by running surveys and/or by retrieving sales data from a source on network 10. The previous position of each company in the marketplace is shown in column 202. Movement of the proprietor 200 relative to its competitors is shown in column 204.

Area 206 lists the most satisfied resellers, among the most important, i.e., highest volume, resellers. Associated with each reseller 210 is a rating 208, which is determined by engine 30 and which indicates a level of reseller satisfaction. Column 210 indicates whether the level of satisfaction has increased (up arrow 212), decreased (down arrow 214) or stayed within a statistical margin of error (dash 216). Column 216 indicates the percentage of change, if any, since a previous survey was run.

Area 218 lists the least satisfied resellers 220, among the most important, i.e., highest volume, resellers. As above, associated with each reseller is a rating 222, which is determined by engine 30 and which indicates a level of reseller satisfaction. Column 224 indicates whether the level of satisfaction has increased (up arrow 226), decreased (by a down arrow) or stayed within a statistical margin of error (dash 228). Column 230 indicates the percentage of change, as above.

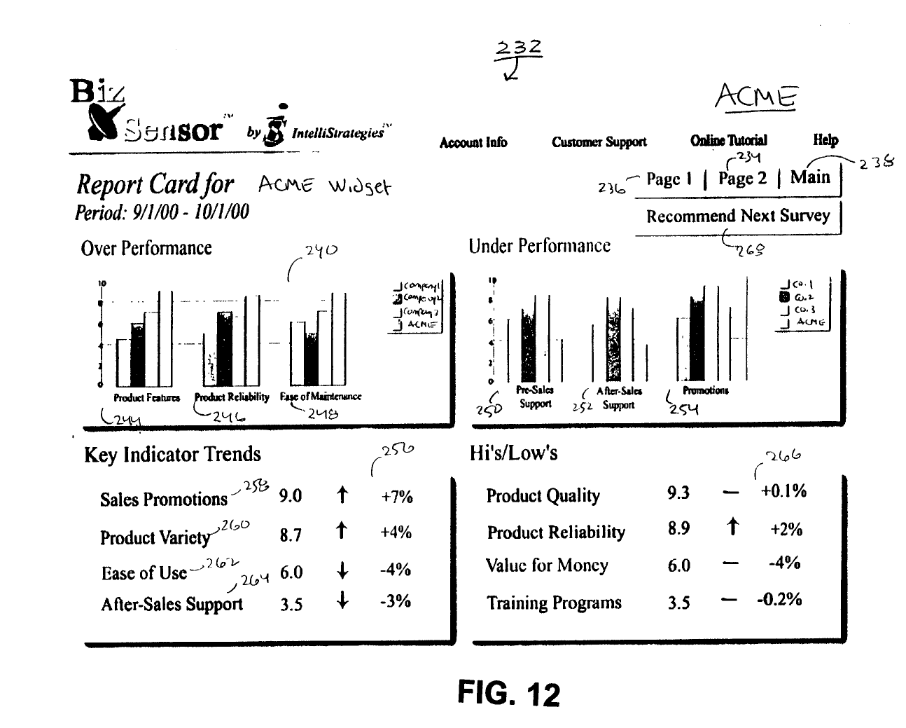

GUI 232 (FIG. 12) shows the second page of the report card. GUI 232 is arrived at by selecting “Page 2” option 234 from GUI 182. Selecting “Page 1” option 236 re-displays GUI 182; and selecting “Main” option 238 re-displays GUI 120 (FIG. 8).

GUI 232 also displays information relating to the proprietor that was obtained/derived from surveys. In this embodiment, the information includes over-performance 240 and under-performance 242 indications. These are displayed as color-coded bar graphs. The over-performance area indicates the performance of the proprietor relative to its competitors along non-critical product/service attributes such as, but not limited to, product features 244, reliability 246 and maintenance 248. The under-performance area indicates the performance of the proprietor relative to its competitors in the areas the respondents have indicated are most important to them. In this example, they are pre-sales support 250, after-sales support 252, and promotion 254. A process for determining under-performance is set forth below in Appendix II. The process for over-performance is similar to that for under-performance and is also shown in Appendix II.

Area 256 displays key indicator trends that relate to the proprietor. The key indicator trends may vary, depending upon the company and circumstances. In the example shown here, engine 30 identifies the key indicator trends as those areas that have the highest and lowest increases. These include sales promotion 258, product variety 260, ease of use 262, and after-sales support 264. The Hi's/Low's area 266 displays information that engine 30 identified as having the highest and lowest ratings among survey respondents. The arrows and percentages shown on GUI 232 have the same meanings as those noted above.

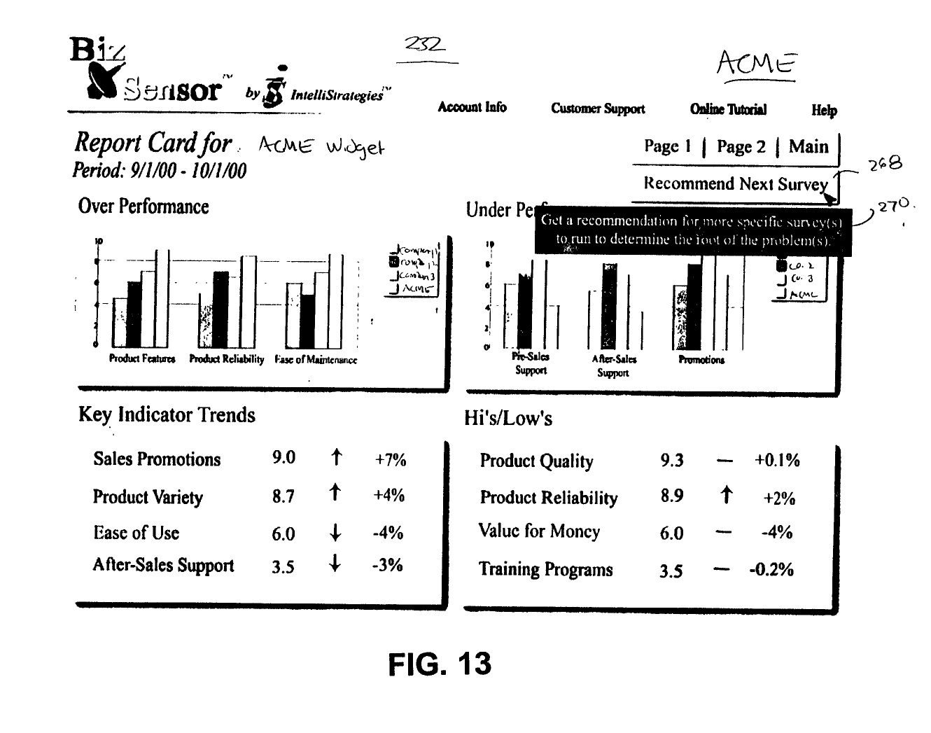

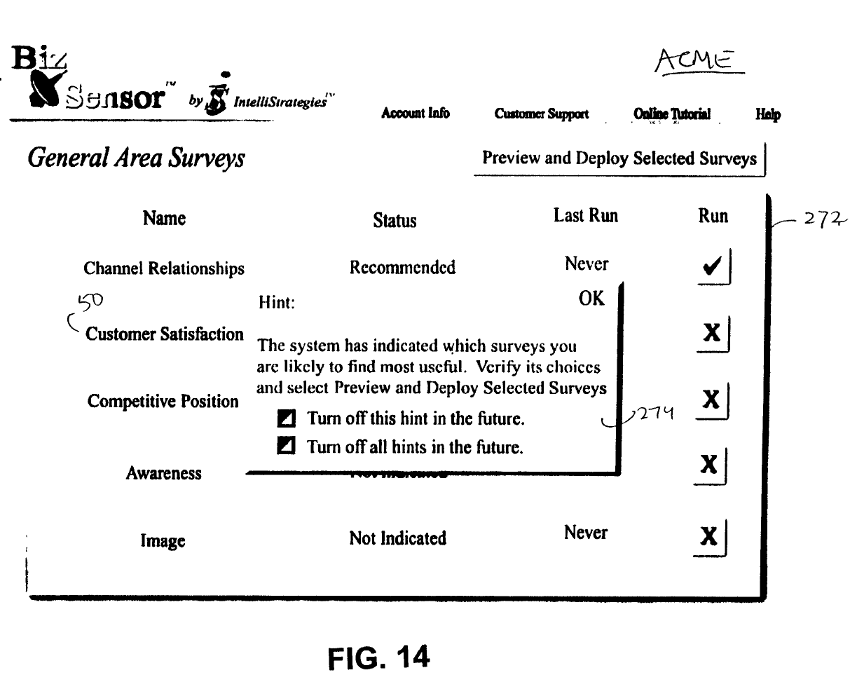

GUIs 182 and 232 includes an option 268 to recommend a next survey, in this case, a follow-up to the general purpose survey. The purpose of option 268 is identified by hint 270 (FIG. 13), which, like the other hints described herein, is displayed by laying the cursor over the option. Selecting option 268 displays GUI 272 (FIG. 14), along with a hint 274 that provides instructions about GUI 272. As hint 274 indicates, GUI 272 displays the list of general area surveys and recommendations about which of those general area surveys should follow the general purpose survey. That is, engine 30 performs a statistical analysis on the responses of the general purpose survey and determines, based on that analysis, if there are any areas that the proprietor should investigate further. For example, if the general purpose survey reveals a problem with customer satisfaction, engine 30 will recommend running the customer satisfaction general area survey 50.

In this regard, a generally accepted practice in marketing is that surveys cannot be excessively long. Respondents—whether distribution channel partners or end users—have limited time and patience, and participation in a survey is almost invariably done on a volunteer basis. Surveys with more than 20 questions are uncommon, the rationale being the more effort required on the part of a respondent, the less likely he is to participate. The problem is also exacerbated by the need to include demographic questions on surveys to build aggregate profiles of respondents for segmentation purposes, which reduces the number of other types of business-focused questions (e.g., behavioral and attitudinal) that can appear. This being the case, it is impossible for any single survey to delve into all aspects of a business, such as customer satisfaction, loyalty, awareness, image perceptions, channel partner relationships, competitive position, etc. Thus, the amount of information any single survey can gather is quite limited.

Engine 30 deals with the foregoing limitations by assisting the user in selecting and running a series of increasingly focused surveys, with the data gathered from each survey being used to determine which follow-up survey(s) need(s) to be run. This type of iteratively increasingly specific analysis is known as “drilling down”. Although a user is free to manually select a survey to run at any time, the system can also recommend a relevant survey based on whatever other data it has collected up until that point to guide the user in gathering increasingly specific information about any encountered problematic or unexpected data.

Each survey in engine 30 is associated with a derived attribute (see above), which represents whether the system believes running that survey is indicated based on gathered data. The precise generating function for deriving an attribute from its proxies is initially hand-coded within expert system rules using the ontology of a knowledge representation language, as in Appendix I. However, feedback from a user (in terms of accepting or rejecting the system's survey recommendations) can alter the weights in the generating functions of the derived attributes corresponding to those surveys. We note that derived attributes can themselves be proxies to other derived attributes, but we can generate a multi-level, feed-forward neural network that calculates the value of each derived attribute in terms of only non-derived attributes. Standard gradient descent learning techniques (e.g., back propagation) can then be used to determine how to generate that derived attribute in terms of its proxies.

When an attribute associated with a survey is derived by the system, a threshold function determines whether running that survey is sufficiently indicated. If so, its value is compared to any other surveys the system is waiting to recommend, in order to limit the number of recommended surveys at any one time. One criterion is that no more than two surveys should be recommended at any one time to keep from overwhelming the user. In the event the system can find no survey to recommend, as is the case when no survey attributes have been derived, it will either recommend running the general purpose survey or none at all if that survey has been recently run.

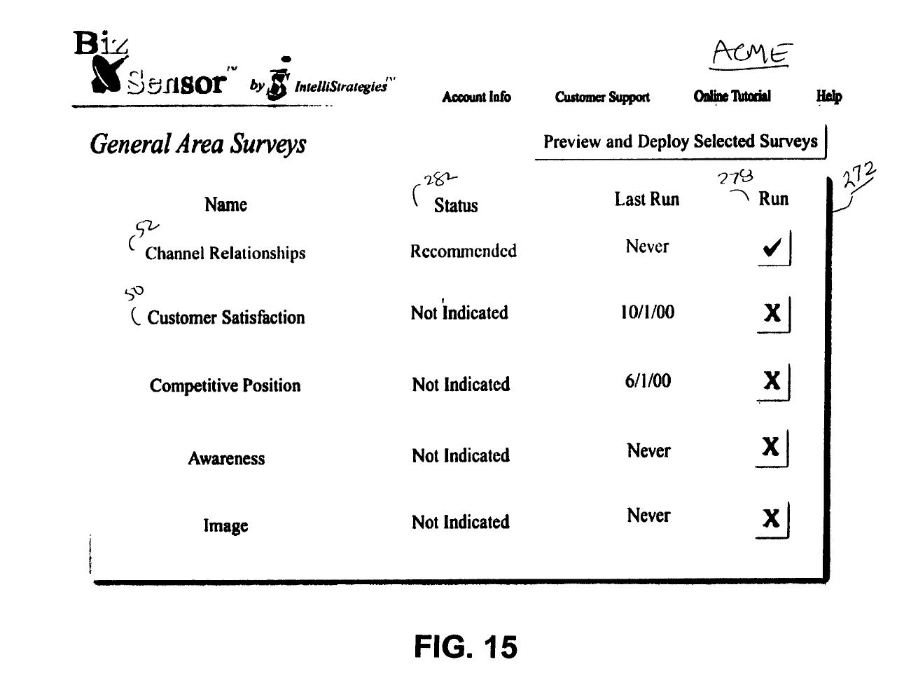

In FIG. 15, which shows GUI 272 without hint 274, an analysis of the responses to the general purpose survey has shown that further investigation of channel relationships is warranted. Therefore, engine 30 recommends running the channel relationships general area survey 52. The other general area surveys are not recommended (i.e., “not indicated”), in this case because the responses to the general purpose survey have not indicated a potential problem in those areas. GUI 272 also provides indications as to whether each of the general area surveys was run previously (276) and the date at which it was last run.

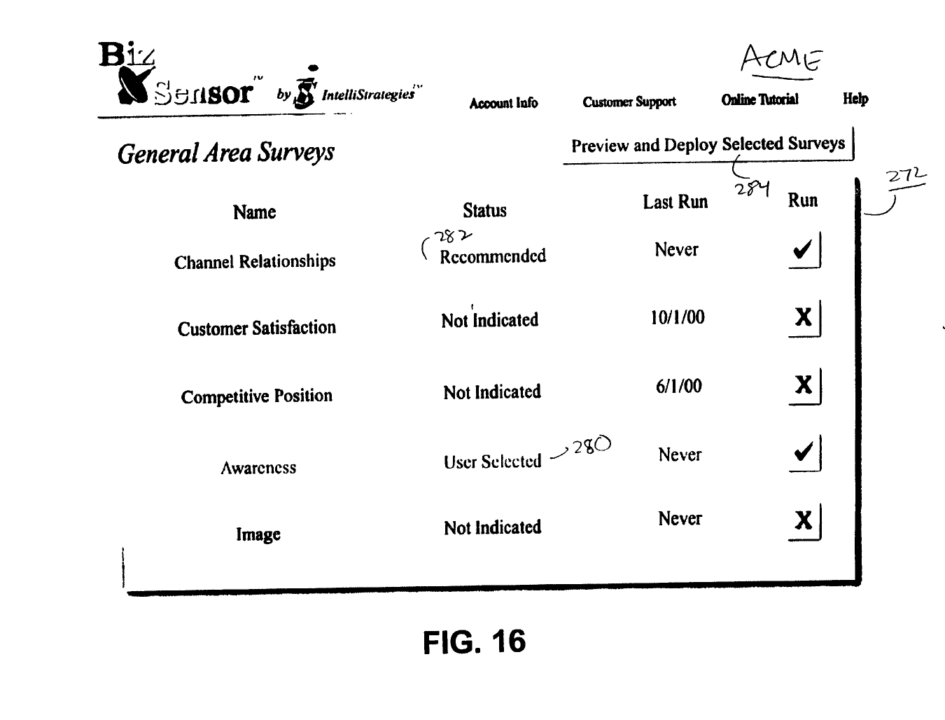

A check mark in “run” column 278 indicates that the survey is to be run. As shown in FIG. 16, a user can select an additional survey 280 to be run, indicated by “user selected” in column 282. Selecting option 284, “Preview and Deploy Selected Surveys”, displays a GUI (not shown) for a selected survey that is similar to GUI 120 (FIG. 8) for the general purpose survey.

Following the same process described above, a newly-selected survey is run and a data display (FIGS. 11 and 12) for that survey is generated. In this example, the channel relationships general area survey was run. Based on the results of this survey, GUI 286 (FIG. 17) displays reseller 288 and competitor 290 satisfaction data.

Clicking on “Recommend Next Survey” option 292 provides recommendation for a focus survey(s) to run based on the analysis of the general area survey responses. That is, engine 30 performs a statistical analysis of the responses to the general area survey and determines, based on that statistical analysis, which, if any, focus survey(s) should be run to further analyze any potential problems uncovered by the general area survey. The next suggested (focus) survey is labeled 117 on FIG. 7.

By providing different levels of surveys, engine 30 is able to identify and focus-in on potential problems relating to a proprietor's business or any other subject matter that is appropriate for a survey. By running the surveys and performing the data collection and analysis automatically (i.e., without human intervention), surveys can be run in real-time, allowing a business to focus-in on problems quickly and efficiently. An added benefit of automatic data collection and analysis is that displays of the data can be updated continuously, or at predetermined intervals, to reflect receipt of new survey responses.

In alternative embodiments, the analysis and display instructions of engine 30 may be used in connection with a manual survey data collection process. That is, instead of engine 30 distributing the surveys and collecting the responses automatically, these functions are performed manually, e.g., by an automated call distribution (ACD) system. An ACD is a system of operators who take surveys and collect responses. The responses collected by the ACD are provided to server 12, where they are analyzed and displayed in the manner described above. Follow-up surveys are also generated and recommended, as described. These follow-up surveys are also run via the ACD.

Although a computer network is shown in FIG. 1, process 18 is not limited to use with any particular hardware or software configuration; it may find applicability in any computing or processing environment. Process 18 may be implemented in hardware, software, or a combination of the two. For example, process 18 may be implemented using programmable logic such as a field programmable gate array (FPGA), and/or application-specific integrated circuits (ASICs).

Process 18 may be implemented in one or more computer programs executing on programmable computers that each include a processor, a storage medium readable by the processor (including volatile and non-volatile memory and/or storage elements), at least one input device, and one or more output devices. Program code may be applied to data entered using an input device to perform process 18 and to generate output information. The output information may be applied to one or more output devices.

Each such program may be implemented in a high level procedural or object-oriented programming language to communicate with a computer system. However, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform process 18. Process 18 may also be implemented as a computer-readable storage medium, configured with a computer program, where, upon execution, instructions in the computer program cause the computer to operate in accordance with process 18.

The invention is not limited to the specific embodiments set forth herein. For example, the information displayed on the various GUIs, such as GUIs 182 and 232, may vary, depending upon the companies, people, products, and surveys involved. Any information that can be collected and derived through the use of surveys may be displayed on the various GUIs. Also, the invention is not limited to using three levels of surveys. Fewer or greater numbers of levels may be used. The number of levels depends on the desired specificity of the responses. Likewise, the graphics shown in the various GUIs may vary. For example, instead of bar graphs, Cartesian-XY plots or pie charts may be used to display data gathered from surveys. The manner of display may be determined automatically by engine 30 or may be selected by a user.

Finally, although the BizSensor™ system by Intellistrategies™ is shown in the figures, the invention is not limited to this, or any other, survey system.

Other embodiments not described herein are also within the scope of the following claims.

### Appendix I

Semantic Tagging (“tagging”) is a process of formatting individual questions and responses in a survey in a formal, machine-readable knowledge representation language (KRL) to enable automated analysis of data obtained via that survey. The semantic tags (or simply “tags”) indicate the meaning of a response to a question in a particular way. The tags are created by a survey author (either a person, a computer program, or a combination thereof) and allow engine 30 to understand both a question and a response to that question.

Tags indicate what the gathered information actually represents and allow the engine 30 to process data autonomously. In particular, the tags allow the data collected by a survey to be directly processed by an expert (i.e., rule-based) or logic programming (e.g., Prolog-based) system in engine 30 without requiring direct human intervention to interpret, categorize, summarize, etc., survey responses. User responses are asserted as facts within an expert system (e.g., within engine 30), where each fact is automatically derived from the tag associated with each question.

Tags represent the information gathered by a particular question, but are not tied to the precise wording of that question. Thus, it is possible for a wide range of natural language questions to have identical semantic tags. The KRL here has a partial ontology for describing survey questions and responses. It is intended to be descriptive and functional and thereby capture the vast majority of questions on marketing surveys.

In this embodiment, surveys are comprised of three types of questions: behavioral, attitudinal, and demographic. Each of these question types has a corresponding unique type of tag which, as noted above, includes question and response fields. Examples of the question fields of these tags are set forth below. In the tags, the following conventions apply:

(1) “51” represents a logical OR operation

(2) plain text represents constants or list headers in an s-expression

(3) bold print represents keyword arguments

(4) italics represent a member of a named set

(5) <brackets> surround optional items

(6) ${NAME} refers to a variable

1.0 Behavioral Questions

The question field tag template for behavioral questions is as follows.

| | |
|---|---|
| (tag | (type behavioral) |

(time

(tense past | present | future)
(startDate date)
<(endDate date)>

)
(activity

(action act | act AND act | act OR act)
(queryRegarding quality)
(object product)
<(subject demographic)>
<(indirectObject demographic)>
<(verb string)>
<(variable string)>
)

<(questionID string)>
(response . . . ))

act ε {Use, Do, Purchase, Replace, License, Own, Sell, Exchange, Recommend, Repair, Visit, Contact, Complain, and similar expressions}

quality ε {Frequency, Length, Existence, Source, Intention, Purpose, Completion, Difficulty, and similar expressions}

string is a “quotation delimited” string of characters.

product is a set of products and/or services offered by a particular client and is industry specific. It is enumerated when the expert system is first installed for a client and subsequently can be modified to reflect the evolution of the client's product line or the client's industry as a whole. Elements of the product set have ad hoc internal structure representing both the client's identity and an item's position in the client's overall hierarchy of product/service offerings. By way of example, an IBM laptop computer is represented by “IBM/product/computer/laptop.”

The demographic set is defined in the section of templates for demographic questions set forth below.

The response field that corresponds to the above question field is specified below.

Each individual question in a survey has a tag that adheres to the above template, but need not assign optional fields. For example, consider the following behavioral questions and their associated tags immediately following the questions.

| | |
|---|---|
| (1) | “Have you used an IBM laptop computer in the past 3 |
| | years?” |

| | |
|---|---|
| (tag | (type behavioral) |

(time

(tense past)
(startDate (${CURRENT_DATE} - 3 YEARS))
(endDate ${CURRENT_DATE}))

(activity

(action Use)
(queryRegarding Existence)
(object “IBM/product/computer/laptop”)

(response

(type YorN)))

| | |
|---|---|
| (2) | “How often do you replace your server?” |

| | |
|---|---|
| (tag | (type behavioral) |

(time

(tense present)
(startDate ${CURRENT_DATE})

)
(activity

(action Purchase)
(queryRegarding Frequency)
(object “any/product/server”)

| (response | |
|---|---|
| | (type Selection) |
| | (selections (choseOne 0 3 6 9 12 18)) |
| | (primitiveInterval Month))) |
| (3) | “What brand of laptop computer do you use now?” |

| | |
|---|---|
| (tag | (type behavioral) |

(time

(tense present)
(startDate ${CURRENT_DATE})

)
(activity

(action Use)
(queryRegarding Source)
(object “current/product/computer/laptop”)
(variable “CURRENT_BRAND”)
)

(response

(type MenuSelection)
(selections (onlyOne “IBM” “Compaq” “NEC” “Gateway”

“Dell” “Sony” “HP”))

(setVariable “CURRENT_BRAND”)))

2.0 Behavioral Questions

The question field tag template for attitudinal questions is as follows.

| | |
|---|---|
| (tag | (type attitudinal) |

(time

(tense past | present | future)
(startDate date)
<(endDate date)>

)
(attitude

(belief belief
(queryRegarding beliefQuality)
<(statement string)>
<(subject demographic)>
(object reference)
(attribute feature)
<(contrast reference)>
<(variable string)>
)

<(questionID string)>
(response . . . ))

belief ε {Satisfaction, Perception, Preference, Agreement, Modification, Plausibility, Reason, and similar expressions}

beliefQuality ε {Degree, Correlation, Absolute, Ranking, Specification, Elaboration, and similar expressions}

feature is a set of features relevant to a particular client's product and/or service offerings. Although many features are industry specific, many such as reliability are fairly universal. The feature set is enumerated when the expert system is first installed for a client and can be subsequently modified to reflect the evolution of the client's product line or industry as a whole.

The response field that corresponds to the above question field is specified below.

It is noted that, for questions with matrix scales, which is a common occurrence in attitudinal questions, each row of the matrix has a separate, unique tag.

Consider the following attitudinal questions and their associated tags, which immediately follow the questions.

| | |
|---|---|
| (1) | “Rate your overall satisfaction with the performance |
| | of the laptop computer you are currently using.” |

| | |
|---|---|
| (tag | (type attitudinal) |

(time

(tense present)
(startDate ${CURRENT_DATE))

)
(attitude

(belief Satisfaction
(queryRegarding Degree)
(object “current/product/laptop/computer”)
(attribute Performance))

(response

| (type HorizontalLikert) | |
|---|---|
| (askingAbout Satisfaction) | |
| (selections | (low 0) |
| | (high 5) |

(interval 1)))

| | |
|---|---|
| (2) | “If you could make one change to your current laptop |
| | computer, what would it be?” |

| | |
|---|---|
| (tag | (type attitudinal) |

(time

(tense present)
(startDate ${CURRENT_DATE})

)
(attitude

(belief Modification
(queryRegarding Specification)
(object “current/product/laptop/computer”))

(response

(type ListSelection)
(selections (onlyone ${FEATURES})))

| | |
|---|---|
| (3) | “Do you agree with the sentiment that laptop computers |
| | will someday replace desktop computers?” |

| | |
|---|---|
| (tag | (type attitudinal) |

(time

(tense present)
(startDate ${CURRENT_DATE))

)
(attitude

(belief Agreement
(queryRegarding Absolute)
(object “any/product/laptop/computer”)
(statement “Laptop computers will someday replace

desktop computers.”))
(response

(type YorNorDontKnow)
(askingAbout Agreement))

| | |
|---|---|
| (4) | “Do you have any additional comments to add?” |

| | |
|---|---|
| (tag | (type attitudinal) |

(time

(tense present)
(startDate ${CURRENT_DATE})

)
(attitude

(belief Perception
(queryRegarding Elaboration)
(object “any/product/laptop/computer”)

)
(response

(type FreeResponse)
(noLines 3)
(width 40)

)

)

3.0 Demographic Questions

The question field tag template for demographic questions is as follows:

| | |
|---|---|
| (tag | (type demographic) |

(time

(tense past | present | future)
(startDate date)
<(endDate date)>

)
(description

<(gender)>
<(age)>
<(ageRange)>
<(haveChildren)>
<(numberChildren)>
<(childAgeByRange)>
<(maritalStatus)>
<(employment)>
<(education)>
<(income)>
<(address)>
<(email)>
<(name)>
<(phoneNumber)>
<(faxNumber)>
<(city)>
<(state)>
<(zipCode)>
<(publicationsRead)>
<(groupMembership)>
<(hobbies)>
<(mediaOutlets)>
<(other string)>

<(qualifier length | prefer | like | dislike

| know | dontKnow)>

)
<(questionID number)>
(response . . . ))

The response field for the above question field is specified below.

By way of example, consider following the demographic questions and their associated tags immediately following the questions.

| | |
|---|---|
| (1) | “What is your gender?” |

| | |
|---|---|
| (tag | (type demographic) |

(time

(tense present)
(startDate ${CURRENT_DATE}))

(description

(gender))

(response

(type Selection)
(selections (onlyOne “Male” “Female”))))

| | |
|---|---|
| (2) | “What is your email address?” |

| | |
|---|---|
| (tag | (type demographic) |

(time

(tense present)
(startDate ${CURRENT_DATE}))

(description

(email))

(response

(type FreeResponse)
(noLines 1)
(width 30)

| | ) |
|---|---|
| ) | |
| (3) | “Row long have you lived at your present address?” |

| | |
|---|---|
| (tag | (type demographic) |

(time

(tense present)
(startDate ${CURRENT_DATE}))

(description

(address)
(qualifier length)

)
(response

(type MenuSelection)
(low 0)
(high 20+)
(primitiveInterval Year)

)

)

4.0 Response Field Template

Questions in surveys can have a variety of different scales for allowing the respondent (i.e., the one taking the survey) to select an answer. The response field of a tag specifies, for each question in the survey, both the general scale-type that the response field uses and how to instantiate that scale to obtain a valid range of answers.

The response field also contains placeholders for the respondent's actual answers and individual (perhaps anonymous) identifier(s). Each completed survey for some respondent leads to all of the tags associated with that survey being asserted as facts in the expert system, with all of the placeholders appropriately filled in by the respondents' answers. For expert systems, such as CLIPS (C-Language Integrated Product System) that do not support nested structures within facts, the actual data representation is a flattened version of the one shown below.

A representative template for the response field is as follows.

(response

(type scale)
<(askingAbout questionTopic)>
<(prompt string)>
<(low number)>
<(high number)>
<(interval number)>
<(scaleLength number)>
<(primitiveInterval time | distance | temperature)>
<(selections (onlyOne | anyOf string+)

<(upto number)>
<(atLeast number)>

)>
<(width number)>
<(noLines number)>
(userSelectionRaw string | number)
(userSelection string)
(userSelectionType string)
(userID number)
(userIDinternal number)
(userIDconfidential string)
(clientID string))

scale ε {Likert, Selection, MenuSelection, YorN, YorNorDontKnow, FreeResponse, HorizontalLikert}

The askingAbout field can be set to have the expert system automatically generate the prompt for selecting an answer.

questionTopic ε {Preference, Sentiment, Belief, Frequency, Comment, and similar expressions}

5.0 Fact Instantiation from Tags

Tags allow the data collected by a survey to be directly processed by an expert (i.e., rule-based) or logic programming (e.g., Prolog-based) system (engine 30) without requiring direct human intervention to interpret, categorize, summarize, etc., survey responses. User responses are asserted as facts within the expert system, where each fact is automatically derived by parsing the relevant information from a corresponding tag associated with each question.

It is noted that that additional information regarding each user is simultaneously instantiated in separate facts within the expert system. This includes for example, the site where the respondent was surveyed, the time of day the survey was taken, and the like.

By way of example, consider the question:

“How often do you speak with your salesman?”, with associated tag:

| | |
|---|---|
| (tag | (type behavioral) |

(time

(tense current)
(startDate ${CURRENT_DATE})

)
(activity

(action Contact)
(queryRegarding Frequency)
(indirectObject “NEC/person/salesman”)
(object “NEC/product/PBX/NEAX2000”))

(response

(type Selection)
(askingAbout Frequency)
(selections (onlyOne 0 3 6 9 12 18))
(primitiveInterval Month)))

If a respondent answering this question selects “3”, as in, “I speak with my salesman every 3 months”, the expert system will automatically assert a fact corresponding to the tag in the expert system, with additional fields representing the user's selection and identity, as well as identifying information about the survey itself. This is set forth as follows.

(answer
(surveyName “PBX Satisfaction”)
(surveyDate 12/17/00)
(surveyVersion “1.0”)
(questionID 3)
(type behavioral)
(time

(tense current)
(startDate 12/17/00)
)

(activity
(action Contact)
(queryRegarding Frequency)
(indirectObject “NEC/person/salesman”)
(object “NEC/product/PBX/NEAX2000”))

(response

(type Selection)
(askingAbout Frequency)
(selections (choseOne 0 3 6 9 12 18))
(primitiveInterval Month)

(userSelectionRaw 3)
(userSelection 3)
(userSelectionType Month)
(userID 127)
(userIDinternal 4208)
(userIDconfidential “mhcoen@intellistrategies.com: uid
0xcf023a8b7”)
(client “NEC/CNG”)
)

In this way, engine 30 is able to interpret the responses to survey questions using tags. The response information is analyzed, as described above, to generate graphical displays and recommend follow-up surveys.

### Appendix II

Over-performance and under-performance graphs are components of the report card. The under-performance display is generated according to the process in section 1.0 below and the over-performance display is generated according to the process in section 2.0 below.

1.0 Under-Performance Display

For client company b (who is running engine 30) &

For each competitor company c &

For each feature f &

For each user u

Such that we know:

(1) (importance of f to u)

(2) (satisfaction rating of company b on feature f to user u)

(3) (satisfaction rating of company c on feature f to user u)

(4) (all involved data is less than 2 months old)

Calculate:

(1) average and variance of satisfaction for each feature over all competitors c)

Call these quantities avg(f) and stddev(f) respectively

(2) (average of satisfaction for each feature for company b)

Call this quantity avg(f,b)

Sort features by importance and proceed through them in decreasing order:

If (avg(f) − avg(f,b) > stddev (f))
Then set rank(f) = (sqrt(importance(f)) * (avg(f) −
avg(f,c))) − penalty(avg(f), stddev(f) \hat{ }2)

We also subtract a penalty term from the rank(f) to discount features with high variance either at the moment (as shown here) or historically.

Loop: Consider the n features with the highest rank, where n is the number of features to be displayed in the under-performance graph. If any of them are proxies for a derived attribute, here a feature, and the other proxy attributes are known, calculate the rank for the derived feature and use it instead.

Go to Loop.

If not, continue.

Generate a chart or graph for each feature and display the features in reverse order by rank.

2.0 Over-Performance Display

For client company b (who is running engine 30) &

For each competitor company c &

For each feature f &

For each user u

Such that we know:

(1) (importance of f to u)

(2) (satisfaction rating of company b on feature f to user u)

(3) (satisfaction rating of company c on feature f to user u)

(4) (all involved data is less than 2 months old)

Calculate:

(1) (average and variance of satisfaction for each feature over all competitors c)

Call these quantities avg (f) and stddev(f) respectively

(2) (average of satisfaction for each feature for company b)

Call this quantity avg(f,b)

Sort features by importance and proceed through them in increasing order:

If (avg(f,b) − avg(f) > stddev (f))
Then set rank(f) = (sqrt(max − importance(f)) * (avg(f)
− avg(f,c))) − penalty(avg(f), stddev(f) \hat{ }2)

We also subtract a penalty term from the rank to discount features with high variance either at the moment (as shown here) or historically. Max represents the maximum feature value (i.e., as determined by the source question's scale).

Loop: Consider the n features with the highest rank. (n is the number of features to be displayed in the under-performance graph). If any of the n features are proxies for a derived attribute (here a feature) and the other proxy attributes are known, calculate the rank for the derived feature and use it instead.

Go to Loop.

If not, continue.

Generate chart for each feature and display them in reverse order by rank.

### Appendix III

Surveys by nature are very specific documents. They are written with respect to a particular inquiry, to a specific industry (or entity), to a particular product, offering, or concept, and for an intended audience of respondents. These determine not only the structure of the overall survey but the particular choice of wording in the questions and the structure, wording, and scale of the question answers.

The system (engine 30) has a library of surveys that it can deploy, but instead of containing the actual text of each of their questions, the surveys contain question templates. Each of these templates captures the general language of the question it represents without making any commitment to certain particulars. The system fills in the details to generate an actual question from a template using an internal model of the client who is running the survey that is created during engine 30's configuration for that client. This model includes the client's industry, product lines, pricing, competitors, unique features and offerings, resellers, demographic targets, customer segmentations, marketing channels, sales forces, sales regions, corporate hierarchy, and retail locations, as well as general industry information, such as expected time frames for product/service use, consumption, and replacement.

Although generating the question templates requires more effort than simply writing questions directly, it avoids the effort of customizing and modifying every The system survey for each new client.

The following are examples of survey questions and the templates that generate them:

1) Purchase frequency:

| | |
|---|---|
| a. | How many laptop computers have you purchased in the |
| | past 10 years? |
| b. | How many airlines tickets do you buy per year? |

(question (variables ${CURRENT_PRODUCT}
${PURCHASE_INTERVAL})

(text

“How many ${CURRENT_PRODUCT} ”

(if ${PURCHASE_INTERVAL == 12) {“do you buy per

year”}

elseif ((mod ${PURCHASE_INTERVAL} 12) == 0)
{“have you bought in the past ”

(${PURCHASE_INTERVAL} / 12)

“ years”}

else {“have you bought in the past

${PURCHASE_INTERVAL} months”}

)

“?”

)

2) Competitive Position/reliability:

| | |
|---|---|
| a. | Which brand of PBX do you think is most reliable? |

□ NEC
□ Nortel
□ Lucent
□ Williams

| | |
|---|---|
| b. | Which type of vehicle do you think is most |
| | reliable? |

□ Pickup Truck
□ SUV
□ Station wagon
□ Sedan

(question (variables ${CATEGORY_REFERENCE}
${CURRENT_PRODUCT}

${MANUFACTURERS})

(text

“Which ${CATEGORY REFERENCE} of

${CURRENT_PRODUCT} do you think is most reliable?”
)
(scale (selections ${MANUFACTURERS})
)

)

1. A computer-implemented method, comprising:
distributing a first survey;
receiving responses to the first survey;
analyzing the responses automatically; and
obtaining a second survey based on the analysis of the responses.

2. The method of claim 1, further comprising:
distributing the second survey;
receiving responses to the second survey;
analyzing the responses to the second survey automatically; and
obtaining a third survey based on the analysis of the responses to the second survey.

3. The method of claim 1, wherein:
the first survey comprises a general survey; and
the second survey comprises a specific survey that is selected based on the responses to the general survey.

4. The method of claim 1, wherein:
the first survey comprises a general survey; and
the second survey is obtained by:
selecting sets of questions from a database based on the responses to the first survey; and
combining the selected sets of questions to create the second survey.

5. The method of claim 1, wherein analyzing comprises validating the responses.

6. The method of claim 1, further comprising:
determining results of the first survey based on the responses; and
displaying the results of the first survey.

7. The method of claim 6, wherein the results of the first survey are displayed on a graphical user interface.

8. The method of claim 7, wherein the analysis comprises:
identifying information in the responses that correlates to predetermined criteria; and
displaying the information on the graphical user interface.

9. The method of claim 1, wherein analyzing is performed by computer software without human intervention.

10. The method of claim 1, wherein:
the first survey is distributed over a computer network to a plurality of respondents; and
the responses are received at a server, which performs the analysis, over a computer network.

11. The method of claim 1, wherein:
the first survey contains questions, each of the questions being formatted as a computer-readable tag; and
the responses comprise replies to the questions, the replies being formatted as part of the computer-readable tag.

12. The method of claim 11, wherein analyzing is performed using the computer-readable tags.

13. The method of claim 1, further comprising:
storing a library of survey templates;
obtaining the first and second surveys using the library of templates.

14. The method of claim 13, wherein the first and second surveys are obtained by:
selecting survey templates; and
adding information to the selected survey templates based on a proprietor of the first and second surveys.

15. The method of claim 1, further comprising:
recommending the second survey based on the responses to the first survey;
wherein obtaining comprises retrieving the second survey in response to selection of the second survey.

16. A graphical user interface (GUI), comprising:
a first area for selecting an action to perform with respect to a survey; and
a second area for displaying information that relates to the survey.

17. The GUI of claim 16, wherein:
the second area displays status information relating to a recently-run survey; and
the GUI further comprises a third area for displaying an analysis of survey results.

18. The GUI of claim 17, wherein the status information comprises a date and a completion status of the recently-run survey.

19. The GUI of claim 17, wherein the analysis of survey results includes information indicating a change in the results relative to prior survey results.

20. The GUI of claim 16, wherein the GUI displays plural actions to perform.

21. The GUI of claim 20, wherein one of the actions comprises displaying a report that relates to the survey.

22. The GUI of claim 21, wherein the report comprises pages displaying information obtained from the survey.

23. The GUI of claim 21, wherein the report comprises information about a product that is the subject of the survey.

24. The GUI of claim 23, wherein the information comprises a comparison to competing products.

25. A computer-readable medium that stores executable instructions that cause a computer to:
distribute a first survey;
receive responses to the first survey;
analyze the responses automatically; and
obtain a second survey based on the analysis of the responses.

26. The computer-readable medium of claim 25, further comprising instructions that cause the computer to:
distribute the second survey;
receive responses to the second survey;
analyze the responses to the second survey automatically; and
obtain a third survey based on the analysis of the responses to the second survey.

27. The computer-readable medium of claim 25, wherein:
the first survey comprises a general survey; and
the second survey comprises a specific survey that is selected based on the responses to the general survey.

28. The computer-readable medium of claim 25, wherein:
the first survey comprises a general survey; and
the second survey is obtained by:
selecting sets of questions from a database based on the responses to the first survey; and
combining the selected sets of questions to create the second survey.

29. The computer-readable medium of claim 25, wherein analyzing comprises validating the responses.

30. The computer-readable medium of claim 25, further comprising instructions that cause the computer to:
determine results of the first survey based on the responses; and
display the results of the first survey.

31. The computer-readable medium of claim 30, wherein the results of the first survey are displayed on a graphical user interface.

32. The computer-readable medium of claim 31, wherein the analysis comprises:
identifying information in the responses that correlates to predetermined criteria; and
displaying the information on the graphical user interface.

33. The computer-readable medium of claim 25, wherein analyzing is performed by computer software without human intervention.

34. The computer-readable medium of claim 25, wherein:
the first survey is distributed over a computer network to a plurality of respondents; and
the responses are received at a server, which performs the analysis, over a computer network.

35. The computer-readable medium of claim 25, wherein:
the first survey contains questions, each of the questions being formatted as a computer-readable tag; and
the responses comprise replies to the questions, the replies being formatted as part of the computer-readable tag.

36. The computer-readable medium of claim 35, wherein analyzing is performed using the computer-readable tags.

37. The computer-readable medium of claim 25, further comprising instructions that cause the computer to:
store a library of survey templates;
obtain the first and second surveys using the library of templates.

38. The computer-readable medium of claim 37, wherein the first and second surveys are obtained by:
selecting survey templates; and
adding information to the selected survey templates based on a proprietor of the first and second surveys.

39. The computer-readable medium of claim 25, further comprising instructions that cause the computer to:
recommend the second survey based on the responses to the first survey;
wherein obtaining comprises retrieving the second survey in response to selection of the second survey.

40. An apparatus comprising:
a memory that stores executable instructions; and
a processor that executes the instructions to:
distribute a first survey;
receive responses to the first survey;
analyze the responses automatically; and
obtain a second survey based on the analysis of the responses.

41. The apparatus of claim 40, wherein the processor executes instructions to:
distribute the second survey;
receive responses to the second survey;
analyze the responses to the second survey automatically; and
obtain a third survey based on the analysis of the responses to the second survey.

42. The apparatus of claim 40, wherein:
the first survey comprises a general survey; and
the second survey comprises a specific survey that is selected based on the responses to the general survey.

43. The apparatus of claim 40, wherein:
the first survey comprises a general survey; and
the second survey is obtained by:
selecting sets of questions from a database based on the responses to the first survey; and
combining the selected sets of questions to create the second survey.

44. The apparatus of claim 40, wherein analyzing comprises validating the responses.

45. The apparatus of claim 40, wherein the processor executes instructions to:
determine results of the first survey based on the responses; and
display the results of the first survey.

46. The apparatus of claim 45, wherein the results of the first survey are displayed on a graphical user interface.

47. The apparatus of claim 46, wherein the analysis comprises:
identifying information in the responses that correlates to predetermined criteria; and
displaying the information on the graphical user interface.

48. The apparatus of claim 40, wherein analyzing is performed by computer software without human intervention.

49. The apparatus of claim 40, wherein:
the first survey is distributed over a computer network to a plurality of respondents; and
the responses are received at a server, which performs the analysis, over a computer network.

50. The apparatus of claim 40, wherein:
the first survey contains questions, each of the questions being formatted as a computer-readable tag; and
the responses comprise replies to each of the questions, the replies being formatted as the computer-readable tag.

51. The apparatus of claim 50, wherein analyzing is performed using the computer-readable tags.

52. The apparatus of claim 40, wherein the processor executes instructions to:
store a library of survey templates;
obtain the first and second surveys using the library of templates.

53. The apparatus of claim 52, wherein the first and second surveys are obtained by:
selecting survey templates; and
adding information to the selected survey templates based on a proprietor of the first and second surveys.

54. The apparatus of claim 40, wherein:
the processor executes instructions to recommend the second survey based on the responses to the first survey; and
obtaining comprises retrieving the second survey in response to selection of the second survey.

55. A method comprising:
distributing a first survey;
receiving responses to the first survey;
analyzing the responses; and
obtaining a second survey based on the analysis of the responses;
wherein distributing and receiving are performed manually via an automated call distribution system and analyzing and obtaining are performed automatically using computer software.
